(19) United States
(12) Patent Application Publication
(10) Pub. No.: US 2022/0399771 A1
(43) Pub. Date: Dec. 15, 2022

(54) Rotor for an Electrical Machine

(71) Applicant: ZF Friedrichshafen AG, Friedrichshafen (DE)

(72) Inventors: Martin Jelinewski, Nonnenhorn (DE); Andreas Hölscher, Uhldingen-Mühlhofen (DE); Stephan Scharr, Friedrichshafen (DE); Manfred Till, Friedrichshafen (DE); Eckhardt Lübke, Friedrichshafen (DE); Mathias Döring, Schwarzach am Main (DE)

(21) Appl. No.: 17/778,426

(22) PCT Filed: Oct. 19, 2020
(86) PCT No.: PCT/EP2020/079360

§ 371 Date: May 20, 2022

(30) Foreign Application Priority Data
Nov. 22, 2019 (DE) 10 2019 218 088.4

(51) Int. Cl. H02K 1/32; H02K 9/19; H02K 1/276; H02K 7/00; B60L 50/51

(52) U.S. Cl. CPC H02K 1/32; H02K 9/19; H02K 1/276; H02K 7/003; B60L 50/51

(57) ABSTRACT

A rotor (2) for an electric machine (1) includes a rotor shaft (3) having at least one cooling duct (4), through which a coolant is flowable, and a laminated core (5) arranged on the rotor shaft (3). The laminated core (5) is arranged axially between a first end plate (6) and a second end plate (7) arranged on the rotor shaft (3). The laminated core (5) includes multiple axial ducts (8) for guiding the coolant through the rotor (2). The axial ducts (8) are fluidically connected to at least one distribution duct (9) in the particular end plate (6, 7) for the inflow of the coolant. The axial ducts (8) are fluidically connected to at least one return duct (16) in the particular other end plate (7, 6) for the outflow of the coolant. The at least one distribution duct (9) in the particular end plate (6, 7) is fluidically connected to the at least one cooling duct (4) at the rotor shaft (3).

### CROSS-REFERENCE TO RELATED APPLICATIONS

The present application is related and had right of priority to German Patent Application No. 102019218088.4 filed in the German Patent Office on Nov. 22, 2019, and is a U.S. national phase of PCT/EP2020/079360 filed in the European Patent Office on Oct. 19, 2020, both of which are incorporated by reference in their entirety for all purposes.

### FIELD OF THE INVENTION

The invention relates generally to a rotor for an electric machine and to an electric machine having a rotor of this type, wherein the electric machine is configured for driving a motor vehicle.

### BACKGROUND

An effective cooling of the electric machine is necessary so that an electric machine for driving a motor vehicle can be operated at high power levels. The waste heat of the electric machine arising at high power levels can be power-limiting for certain applications, for example, electrically driven axles. It is not only the temperature in the winding overhangs of the stator of the electric machine that is critical, but also the temperature of the rotor. As soon as the electric machine exceeds a limiting temperature, a control unit of the electric machine typically reduces the power.

For example, DE 10 2018 009 845 A1 discloses a rotor for an electric machine. The rotor includes a rotor shaft as well as a laminated core arranged on the rotor shaft, which is arranged in the axial direction of the rotor shaft between end plates situated on the rotor shaft. The end plates are clamped to one another in the axial direction, as the result of which the laminated core is also clamped in the axial direction. Moreover, at least one cooling duct is provided, which extends within the rotor shaft and through which a cooling medium can flow in order to cool the rotor. By the cooling duct, the laminated core can be acted upon by the cooling medium. The laminated core is spaced apart from the rotor shaft toward the outside in the radial direction at least in one longitudinal portion extending in the axial direction between the end plates, as the result of which an intermediate space is formed, which is arranged in the radial direction between the rotor shaft and the laminated core and into which the cooling duct opens via an outlet opening into the intermediate space, and so the cooling medium flowing through the cooling duct flows into the intermediate space via the outlet opening. As a result, the laminated core is supplied with the cooling medium, which is leaking out of the cooling duct via the outlet opening, from the inside toward the outside in the radial direction, and so a film cooling is formed at the rotor lamination. Subsequent thereto, the cooling medium flows onto the winding overhangs of the stator winding due to the angular acceleration and effectuates an additional winding overhang cooling.

### SUMMARY OF THE INVENTION

Example aspects of the present invention provide a rotor for an electric machine and an electric machine having improved cooling.

A rotor for an electric machine according to example aspects of the invention includes a rotor shaft having at least one cooling duct, which is formed within the rotor shaft and through which a coolant is flowable, and a laminated core arranged on the rotor shaft. The laminated core is arranged axially between a first end plate and a second end plate arranged on the rotor shaft. The laminated core includes multiple axial ducts for guiding the coolant through the rotor. The axial ducts are fluidically connected to at least one distribution duct in the particular end plate for the inflow of the coolant. The axial ducts are fluidically connected to at least one return duct in the particular other end plate for the outflow of the coolant. The at least one distribution duct in the particular end plate is fluidically connected to the at least one cooling duct at the rotor shaft.

In other words, the at least one distribution duct is configured for delivering coolant out of the rotor shaft into the axial ducts of the laminated core, and the at least one return duct is configured for allowing the coolant to flow out of the axial ducts. Preferably, multiple distribution ducts and return ducts are formed in the particular end plate. The two end plates are therefore provided for the inflow of the coolant into the axial ducts as well as for the outflow of the coolant out of the axial ducts. A fluidic connection is to be understood as a connection between two fluid-conveying components or ducts, which effectuates a flow of the coolant.

The electric machine includes the rotatable rotor and a housing-affixed stator and can be operated as a motor or as a generator. When the electric machine is operated as a motor, an, in particular, time-varying voltage can be applied to the stator and to the windings located therein, in order to generate a time-varying magnetic field, which acts in the rotor to induce a torque and, thus, generate a turning motion. When the electric machine is operated as a generator, for example, electrical energy can be generated by inducing a varying magnetic field, for example, via rotation of the rotor, in a looped or coiled conductor of the stator, in order to induce a current in the conductor.

Initially, the rotor shaft is cooled by the through-flow of the coolant via the cooling duct, which is preferably centrally formed in the rotor shaft. The coolant is designed, in particular, as cooling liquid, for example, based on oil or based on water. The coolant is provided for absorbing and dissipating heat. For this purpose, the coolant flows into the cooling duct of the rotor shaft and, via the at least one distribution duct in the particular end plate, to the axial ducts in the laminated core of the rotor. Along the flow path, the coolant withdraws heat from the particular components, through which coolant flows, and thereby cools the particular components. Thereafter, the coolant is discharged via the at least one return duct in the particular end plate and re-cooled, for example, by a heat exchanger, in order to then be returned to the cooling duct in the rotor shaft and, in this way, form a cooling circuit.

The laminated core includes sheet metal layers arranged, for example, consecutively or one behind the other in the axial direction of the rotor. Magnets, in particular permanent magnets, are arranged in recesses of the laminated core. The axial ducts in the laminated core are preferably formed in areas that already have indentations due to the geometry of the metal sheet. Preferably, the metal sheets of the laminated core form the wall of the particular axial ducts, wherein the coolant then directly contacts surfaces of the laminated core while flowing through the axial ducts.

For example, an inflow for the coolant is formed at an inner circumference of the particular end plate, wherein the inflow is fluidically connected to the at least one distribution duct. The inflow at the particular end plate is preferably formed via a circumferential distribution duct at the inner circumference of the particular end plate. In particular, the circumferential distribution duct is fluidically connected to multiple distribution ducts for introducing the coolant into the axial ducts. In particular, the distribution ducts extend toward the outside at least partially in the radial direction from the circumferential distribution duct at the inner circumference. The particular end plate includes, in particular, a central bore for the axial passage of the rotor shaft, wherein the inflow is directly adjacent to the central bore.

For example, an outflow for the coolant is formed by at least one end-face opening in the return duct of the particular end plate. In other words, the at least one end-face opening in the return duct of the particular end plate is configured for discharging the coolant in a targeted manner. In particular, the coolant flows via the inflow at the particular end plate out of the cooling duct of the rotor shaft into the axial ducts and flows out again, in a controlled manner, via the opening in the return duct of the particular end plate configured as an outflow.

For example, the at least one opening is configured for spraying coolant onto components of the electric machine. In particular, the coolant is sprayed, via the at least one opening and, thus, in a controlled manner, onto winding overhangs of the stator or onto a particular end face of the rotor. As a result, in particular, the cooling potential increases due to the large and direct wetting of the surfaces of the windings and of the rotor, wherein a direct and immediate cooling is effectuated at the point of the heat development, in particular at the winding overhangs of the stator.

Preferably, the at least one opening is configured for accommodating an orifice. An orifice is to be understood as an element that at least partially closes the particular opening and/or changes a cross-section of the particular opening in such a way that the flow rate and, in particular, also a spray direction and a spray jet are adjusted. In addition to the flow rate, the orifice also adjusts a pressure of the coolant in the axial ducts. Preferably, a coolant distribution up to the components of the electric machine that are to be cooled is achieved via the particular orifice in the particular opening, in particular at low rotational speeds. Moreover, a suction effect for the coolant can be adjusted via the orifices in such a way that a constant flow resistance is set, regardless of the direction of rotation and the length and the cross-section of the particular duct for guiding the coolant.

For example, the at least one distribution duct and the at least one return duct are each formed as an indentation in the end face of the particular end plate facing the laminated core. The particular end plate comes to rest axially against a particular end-face end of the laminated core and, in fact, in such a way that the at least one distribution duct and the at least one return duct rest against the laminated core in a fluid-tight manner. Consequently, a seal of the at least one distribution duct and of the at least one return duct is formed at the laminated core at least indirectly, for example, via at least one seal between the particular end plate and the laminated core, or directly, and so no coolant can unintentionally flow out of the at least one distribution duct or the at least one return duct via the end faces of the laminated core. In particular, the particular end plate is axially clamped with the particular laminated core.

Preferably, the axial ducts are formed in the laminated core so as to be continuously distributed over the circumference of the rotor. In other words, the rotor is cooled via the axial ducts formed in the laminated core continuously in the circumferential direction, i.e., over three hundred and sixty degrees (360°). For example, the axial ducts are formed uniformly, preferably symmetrically, in the laminated core of the rotor and extend from one end-face end to the other end-face end of the rotor.

According to one preferred example embodiment of the invention, the axial ducts are configured for being impinged upon by the flow of coolant in alternation from the first end plate and the second end plate in order to establish a homogeneous temperature distribution over the circumference of the rotor. Consequently, the axial ducts and the end plates are designed in such a way that the through-flow of coolant, i.e., the through-flow of coolant in the axial ducts, takes place in alternation from the first end plate to the second end plate and from the second end plate to the first end plate in the circumferential direction. This enables not only a homogeneous cooling and temperature distribution in the rotor, but also a homogeneous cooling of the winding overhangs and/or an end-face cooling of the rotor on both sides.

In order to establish a homogeneous temperature distribution over the circumference of the rotor, the coolant is introduced into the axial ducts, for example, via the first end plate, and is discharged out of the axial ducts via the second end plate and optionally sprayed onto winding overhangs of the stator and a first end face of the rotor. In every second axial duct as viewed in the circumferential direction, the coolant is then introduced into the axial ducts via the second end plate and is discharged out of the axial ducts via the first end plate and optionally sprayed onto winding overhangs of the stator and a second end face of the rotor.

Alternatively, an alternating direction of through-flow in the axial ducts can also be achieved, for example, due to the fact that coolant is introduced into the axial ducts via the first end plate, deflected via the second end plate into a particular second axial duct that is adjacent in the circumferential direction and, via the particular second axial duct axial duct, is introduced back into the first end plate, wherein the coolant is optionally sprayed out of the first end plate onto winding overhangs of the stator and the second end face of the rotor. In every third axial duct as viewed in the circumferential direction, coolant is then introduced into the axial ducts via the second end plate, deflected via the first end plate into a particular fourth axial duct that is adjacent in the circumferential direction and, via the particular fourth axial duct axial duct, is introduced back into the second end plate, wherein the coolant is optionally sprayed out of the second end plate onto winding overhangs of the stator and the first end face of the rotor.

According to one preferred example embodiment of the invention, cooling fins for heat dissipation are formed in the axial ducts. The heat dissipation is improved by the cooling fins in the axial ducts and, in fact, by achieving a greater wetting of the area that is effective for the cooling. For example, the flow speed of the coolant is also increased by cooling fins in the axial ducts due to the reduction of the cross-section. In particular, the efficiency of the cooling fins can be increased when the flow at the cooling fins is established in a laminar manner at least partially or in sections. An optimized flow guidance of the coolant for improved heat dissipation can be achieved, in particular, by adapting geometries as well as targeted deflections and a through-flow of the axial ducts with coolant alternating over the circumference.

According to one preferred example embodiment of the invention, the particular cooling fin has a first web, a second web, and a third web, wherein the three webs divide the axial duct into three axial duct areas and extend at least partially in the axial direction of the axial duct. In particular, the particular cooling fin in the particular axial duct extends across the entire length of the axial duct. The first web, the second web, and the third web are designed in such a way that the first web, the second web, and the third web extend radially inward from the wall of the axial duct and meet in a common center. The three webs can be, for example, equally long or have different lengths. In particular, only two of the three webs can be equally long.

According to one preferred example embodiment of the invention, the axial ducts include a fluid seal. For example, the fluid seal of the axial ducts takes place via bonding of the laminated core. According to one further example embodiment, the fluid seal of the axial ducts takes place via inserts, which are fluid-tight and adapt to the geometry of the particular axial duct, i.e., are designed to be corresponding thereto. For example, an insert is to be understood as a circumferentially closed hose or as piping the particular axial duct.

According to one preferred example embodiment of the invention, the axial ducts include means for forming turbulence. The generation of turbulence in the coolant can result in the increase of heat dissipation and, thus, to improved cooling. The means for forming turbulence are preferably designed as raised areas and/or indentations in the axial ducts. In addition, edges can be formed in the axial ducts by turning and/or twisting segments of the rotor laminated core, which can generate additional turbulence. Further geometries and/or contours for forming turbulence are also conceivable.

According to one preferred example embodiment of the invention, the axial ducts are arranged at the rotor in the area of magnets. In particular, magnets are formed at least partially between axial ducts. Preferably, axial ducts abut magnets in the laminated core, at least in sections or completely. For example, more and/or larger axial ducts are arranged at temperature-critical magnets, which have a relatively higher temperature development, in order to cool these magnets to a greater extent, in particular to dissipate more heat at these magnets. The closer the axial ducts are arranged to the heat-developing components of the rotor, the smaller is the thermal action chain and the higher is the efficiency of the cooling.

For example, the at least one distribution duct and the at least one return duct in the particular end plate are both designed in an I-shape or a Y-shape. A distribution duct or a return duct designed in an I-shape has an essentially linear geometry and is designed, in particular, as a straight groove, which is preferably designed extending radially outward from the inner circumference of the end plate. By comparison, a distribution duct or a return duct designed in a Y-shape has an essentially linear geometry, at which two further linear geometries extend toward one side and increasingly move radially outward away from one another. Preferably, the I-shaped or Y-shaped geometry of the at least one distribution duct and of the at least one return duct can be at least partially supplemented by further geometries in order to fluidically couple further axial ducts.

Example aspects of the invention further relate to an electric machine for driving a motor vehicle, including a rotor according to example aspects of the invention. The electric machine is utilized either alone or in combination with a further electric machine or an internal combustion engine for driving the motor vehicle. For example, the electric machine is configured for driving an axle of the motor vehicle.

### BRIEF DESCRIPTION OF THE DRAWINGS

Preferred exemplary embodiments of the invention are explained in greater detail in the following with reference to the drawings, wherein identical elements are labeled with the same reference character, wherein:

FIG. 1 shows a perspective schematic of an only partially represented electric machine according to example aspects of the invention;

FIG. 2 shows a diagrammatic longitudinal sectional representation of the example electric machine according to FIG. 1;

FIG. 3 shows a perspective schematic of two end plates and an only partially represented rotor of the example electric machine according to FIG. 1 and FIG. 2;

FIG. 4a shows a perspective schematic of one of the two identically designed end plates according a first exemplary embodiment;

FIG. 4b shows a perspective schematic of one of the two identically designed end plates according a second exemplary embodiment;

FIG. 5 shows a diagrammatic cross-sectional representation of the example electric machine according to FIG. 1 through FIG. 3; and

FIG. 6 shows a diagrammatic cross-sectional representation of a preferably designed axial duct in the laminated core of the rotor.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

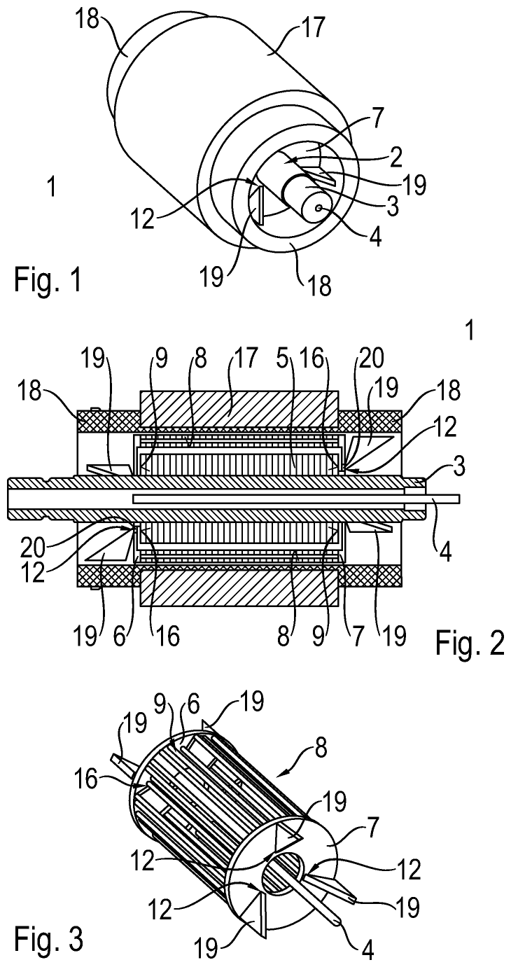

According to FIG. 1, an only partially represented electric machine 1 according to example aspects of the invention includes a housing-affixed stator 17 and a rotatable rotor 2, which is arranged within the stator 17 and, in the present case, is concealed by the stator 17, i.e., is not visible. In FIG. 1, all that is visible of the rotor 2 is a rotor shaft 3 having a cooling duct 4 formed therein.

According to FIG. 2, the electric machine 1 according to FIG. 1 is represented in a longitudinal section, wherein the rotor 2 is visible in a cutting plane in the present case. The rotor 2 includes the rotor shaft 3 and a laminated core 5 arranged on the rotor shaft 3. The rotor shaft 3 has a cooling duct 4, wherein coolant flows through the cooling duct 4 in order to cool the rotor shaft 3. Moreover, the laminated core 5 has multiple axial ducts 8, which are fluidically connected to the cooling duct 4 in the rotor shaft 3 in order to cool the rotor 2. For this purpose, a first end plate 6 and a second end plate 7 are arranged on the end faces of the laminated core 5 and coaxially to the rotor shaft 3.

Multiple distribution ducts 9, which are distributed over the circumference, are formed as an indentation in the end face of the particular end plate 6, 7 facing the laminated core 5. The distribution ducts 9 are utilized for introducing the coolant out of the cooling duct 4 into the axial ducts 8. Moreover, multiple return ducts 16, which are distributed over the circumference, are also formed as an indentation in the end face of the particular end plate 6, 7 facing the laminated core 5. The return ducts 16 are utilized for discharging the coolant out of the axial ducts 8.

According to FIG. 1 and FIG. 2, the stator 17 includes winding overhangs 18 toward both end faces, which protrude out of the end faces of the stator 17. These winding overhangs 18 are sprayed by three coolant jets 19 on both sides and are cooled as a result, wherein only two of the three coolant jets 19 are represented in the present case. The coolant flows via the cooling duct 4 in the rotor shaft 3 into the distribution ducts 9 at the first end plate 6 and the second end plate 7. The distribution ducts 9 introduce the coolant into the axial ducts 8 formed in the laminated core 5. Via the return ducts 16 in the particular end plate 6, 7, the coolant is discharged out of the axial ducts 8 via a particular outflow 11. The outflow 11 for the coolant is formed by an end-face opening 12 in the particular return duct 16 of the particular end plate 6, 7. This opening 12 is configured for spraying coolant, in a targeted and controlled manner, onto components of the electric machine 1, in the present case onto the winding overhangs 18 of the stator 17. For this purpose, a particular orifice 20 is arranged in the particular opening 12, which adjusts the coolant flow, in particular the through-flow and pressure, in the axial ducts 8.

In FIG. 3, the stator 17, the rotor shaft 3, and the laminated core 5 of the rotor 2 are not shown, wherein only the two end plates 6, 7, the axial ducts 8 formed in the laminated core 5, and the cooling duct 4 formed in the rotor shaft 3 are represented. The distribution ducts 9 and the return ducts 16 are distributed over the circumference of the particular end plate 6, 7 and arranged in alternation, wherein the three coolant jets 19 at the second end plate 7 spraying out of the openings 12 in the return ducts 16 are represented in the present case. Due to the perspective representation, only two of the three coolant jets 19 are visible at the return ducts 16 in the first end plate 6. Moreover, the distribution ducts 9 and the return ducts 16 in the second end plate 7 are also not visible in the present case due to the perspective representation.

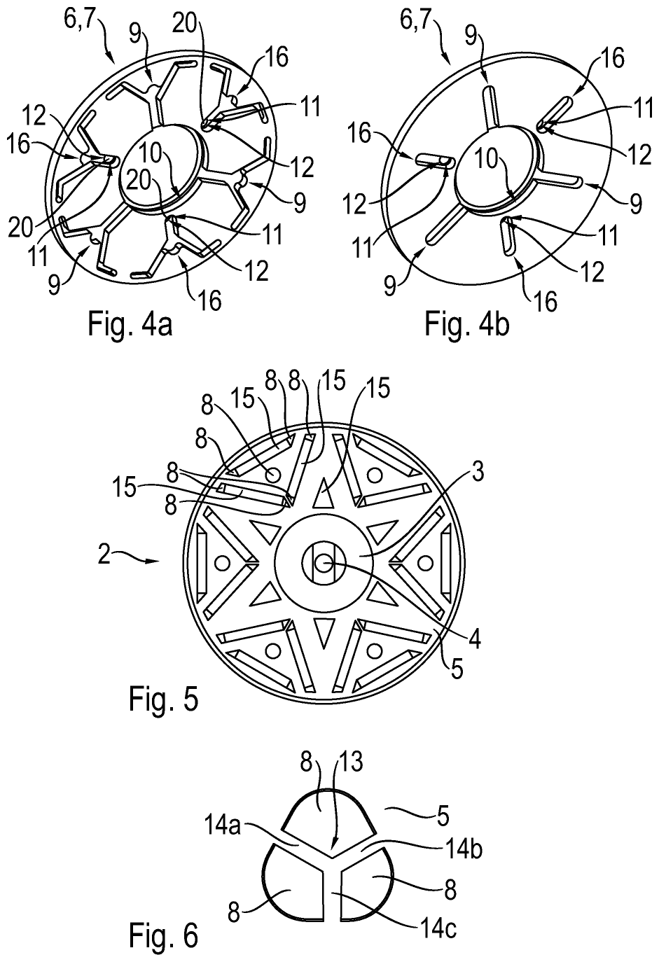

FIG. 4a shows the first end plate 6 according to FIG. 3 in an enlarged perspective representation. The two end plates 6, 7 of the electric machine 1 are identically designed and, in the installed condition, are arranged on the end faces of the laminated core 5 turned by sixty degrees (60°) in the circumferential direction with respect to one another. The representation and explanation of the first end plate 6 also applies for the second end plate 7 due to the identical design. The distribution ducts 9 and the return ducts 16, which are distributed in an alternating and continuous manner in the circumferential direction, are designed as an indentation in the end face of the particular end plate 6, 7 facing the laminated core 5. Consequently, the axial ducts 8, which are fluidically connected thereto, are also formed in the laminated core 5 so as to be continuously distributed over the circumference of the rotor 2 (see FIG. 3). The axial ducts 8 are impinged upon by the flow of coolant from the first end plate 6 and the second end plate 5 in alternation in the circumferential direction in order to establish a homogeneous temperature distribution over the circumference of the rotor 2. The particular distribution duct 9 and the particular return duct 16 are designed essentially in a Y-shape, wherein the particular distribution duct 9 and the particular return duct 16 are simultaneously fluidically connected to multiple axial ducts 8. The inflow 10 for the coolant is designed as an end-face indentation at an inner circumference of the particular end plate 6, 7. The inflow 10 is designed in a ring shape and is fluidically connected to all three distribution ducts 9. By comparison, the outflow 11 for the coolant is formed by the particular end-face opening 12 in each of the three return ducts 16. Coolant is sprayed onto components of the electric machine 1 through the particular opening 12. The particular orifice 20 is accommodated in the particular opening 12 for adjusting a flow rate and a geometry of the coolant jet 19.

According to FIG. 4b, one further example embodiment for the end plates 6, 7 is represented. This example embodiment of the end plates 6, 7 has a simplified geometry for the distribution ducts 9 and the return ducts 16. In the installed condition at the electric machine 1, the identically designed end plates 6, 7 are arranged on the end faces of the laminated core 5 so as to be turned by sixty degrees (60°) in the circumferential direction with respect to one another. The distribution ducts 9 and the return ducts 16, which are distributed in an alternating and continuous manner in the circumferential direction, are designed as an indentation in the end face of the particular end plate 6, 7 facing the laminated core 5, and so the axial ducts 8 are impinged upon by the flow of coolant from the first end plate 6 and the second end plate 7 in alternation in the circumferential direction in order to establish a homogeneous temperature distribution over the circumference of the rotor 2. The particular distribution duct 9 and the particular return duct 16 are designed essentially in an I-shape, wherein the particular distribution duct 9 and the particular return duct 16 are simultaneously fluidically connected to multiple axial ducts 8. The inflow 10 for the coolant is designed as an end-face indentation at an inner circumference of the particular end plate 6, 7. The inflow 10 is designed in a ring shape and is fluidically connected to all three distribution ducts 9. By comparison, the outflow 11 for the coolant is formed by the particular end-face opening 12 in each of the three return ducts 16. Coolant is sprayed onto components of the electric machine 1 through the particular opening 12.

FIG. 5 shows a cross-section of the rotor 2 of the electric machine 1 according to FIG. 1 through FIG. 3. According to this preferred example embodiment, eighteen (18) magnets 15 are arranged in the laminated core 5 of the rotor 2. The pattern formed from the three magnets 15 labeled with reference characters repeats uniformly five times in the circumferential direction. Moreover, according to this preferred example embodiment, forty-two (42) axial ducts 8 are arranged in the laminated core 5 of the rotor 2, wherein the pattern formed from the seven axial ducts 8 labeled with reference characters repeats uniformly five times in the circumferential direction. In the present case, each of three magnets 15 of elongate design is arranged between two axial ducts 8. In each case, three magnets 15 of elongate design essentially form, together, a triangle, wherein an axial duct 8 having a round and larger cross-sectional area is arranged in the center of each particular triangle. The arrangement of the axial ducts 8 in the area of the magnets 15 enables an efficient cooling of the rotor 2. The coolant is introduced into the axial ducts 8 via the cooling duct 4 formed in the rotor shaft 3 and the distribution ducts 9 formed in the end plates 6, 7 and is sprayed onto the winding overhangs 18 of the stator 17 via the openings 12 in the return ducts 16 of the end plates 6, 7.

FIG. 6 shows one preferred example embodiment of an axial duct 8 in the laminated core 5 of the rotor 2. In the present case, a cooling fin 13 is formed in the axial duct 8 for improved heat dissipation. The cooling fin 13 has a first web 14a, a second web 14b, and a third web 14c, wherein the three webs 14a, 14b, 14c divide the axial duct 8 into three axial duct areas. The cooling fin 13 extends in the axial direction of the axial duct 8 and includes a fluid seal, as is also the case for the wall of the axial duct 8 adjacent to the laminated core 5. Therefore, no coolant can leak out of the axial duct 8 in the radial direction via the laminated core 5. Optionally, although not represented here, means for forming turbulence can be formed in the axial ducts 8, preferably at the cooling fins 13.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 electric machine
2 rotor
3 rotor shaft
4 cooling duct
5 laminated core
6 first end plate
7 second end plate
8 axial duct
9 distribution duct
10 inflow
11 outflow
12 opening
13 cooling fin
14a first web
14b second web
14c third web
15 magnet
16 return duct
17 stator
18 winding overhang
19 coolant jet
20 orifice

1-15. (canceled)

16. A rotor (2) for an electric machine (1), comprising:
a rotor shaft (3) including at least one cooling duct (4) formed within the rotor shaft (3) and through which a coolant if flowable;
a first end plate (6) arranged on the rotor shaft (3);
a second end plate (7) arranged on the rotor shaft (3); and
a laminated core (5) arranged on the rotor shaft (3), the laminated core (5) arranged axially between the first end plate (6) and the second end plate (7),
wherein the laminated core (5) includes a plurality of axial ducts (8) for guiding the coolant through the rotor (2), each of the plurality of axial ducts (8) is fluidically connected to at least one distribution duct (9) in a respective one of the first and second end plates (6, 7) configured for inflow of the coolant, each of the plurality of axial ducts (8) is fluidically connected to at least one return duct (16) in a respective one of the first and second end plates (7, 6) configured for outflow of the coolant, and the at least one distribution duct (9) in the respective one of the first and second end plates (6, 7) configured for inflow of the coolant is fluidically connected to the at least one cooling duct (4) at the rotor shaft (3).

17. The rotor (2) of claim 16, wherein an inflow (10) for the coolant is formed at an inner circumference of the respective one of the first and second end plates (6, 7) configured for inflow of the coolant, and the inflow (10) is fluidically connected to the at least one distribution duct (9).

18. The rotor (2) of claim 16, wherein an outflow (11) for the coolant is formed by at least one end-face opening (12) in the return duct (16) of the respective one of the first and second end plates (7, 6) configured for outflow of the coolant.

19. The rotor (2) of claim 18, wherein the at least one end-face opening (12) is configured for spraying coolant onto components of the electric machine (1).

20. The rotor (2) of claim 18, wherein the at least one opening (12) is configured for accommodating an orifice (20).

21. The rotor (2) of claim 16, wherein the at least one distribution duct (9) are each configured as an indentation in an end face of the respective one of the first and second end plates (6, 7) configured for inflow of the coolant facing the laminated core (3), and the at least one return duct (16) are each configured as an indentation in an end face of the respective one of the first and second end plates (7, 6) configured for outflow of the coolant facing the laminated core (3).

22. The rotor (2) of claim 16, wherein the plurality of axial ducts (8) are formed in the laminated core (5) such that the plurality of axial ducts (8) are continuously distributed over a circumference of the stator (2).

23. The rotor (2) of claim 16, wherein the plurality of axial ducts (8) are configured for being impinged upon by a flow of coolant from the first end plate (6) and the second end plate (7) in alternation.

24. The rotor (2) of claim 16, wherein cooling fins (13) for heat dissipation are formed in the plurality of axial ducts (8).

25. The rotor (2) of claim 24, wherein:
each of the plurality of cooling fins (13) comprises a first web (14a), a second web (14b), and a third web (14c); and
the first, second, and third webs (14a, 14b, 14c) divide each of the plurality of axial ducts (8) into three axial duct areas and extend at least partially in the axial direction of the respective axial duct of the plurality of axial ducts (8).

26. The rotor (2) of claim 16, wherein each of the plurality of axial ducts (8) comprises a fluid seal.

27. The rotor (2) of claim 16, wherein each of the plurality of axial ducts (8) comprises means for forming turbulence.

28. The rotor (2) of claim 16, wherein the plurality of axial ducts (8) are arranged at the rotor (2) proximate magnets (15).

29. The rotor (2) of claim 16, wherein the at least one distribution duct (9) and the at least one return duct (16) are each designed in an I-shape or a Y-shape in the respective one of the first and second end plates (6, 7).

30. An electric machine (1) for driving a motor vehicle, comprising the rotor (2) of claim 16.
